(19) United States
(12) Patent Application Publication
(10) Pub. No.: US 2025/0363354 A1
(43) Pub. Date: Nov. 27, 2025

(54) COMPOSING MACHINE LEARNING MODELS TO PERFORM NEW TASKS

(71) Applicant: Google LLC, Mountain View, CA (US)

(72) Inventors: Rachit Bansal, New Delhi (IN); Bidisha Samanta, Bengaluru (IN); Siddharth Dalmia, Mountain View, CA (US); Nitish Gupta, Bengaluru (IN); Shikhar Vashishth, Bareilly (IN); Sriram Ganapathy, Bengaluru (IN); Abhishek Bapna, Bengaluru (IN); Prateek Jain, Bengaluru (IN); Partha Pratim Talukdar, Bengaluru (IN)

(21) Appl. No.: 19/220,068

(22) Filed: May 27, 2025

(30) Foreign Application Priority Data
May 24, 2024 (IN) 202411040663

(51) Int. Cl. G06N 3/08

(52) U.S. Cl. CPC G06N 3/08

(57) ABSTRACT

Methods, systems, and apparatus, including computer programs encoded on computer storage media, for composing machine learning models to perform new tasks.

### CROSS-REFERENCE TO RELATED APPLICATION

This application claims priority under 35 U.S.C. § 119(a) to India application No. 202411040663, filed in the India Patent Office on May 24, 2024. The disclosure of the foregoing application is herein incorporated by reference in its entirety.

### BACKGROUND

This specification relates processing data using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that performs a task by augmenting a base neural network with one or more augmenting neural networks.

In other words, the system “composes” multiple neural networks to generate a composed neural network that can be used to perform one or more tasks, even if the base neural network has not been trained to perform one or more of the tasks. In some cases, the composed neural network can be used to effectively perform a task even if neither the base neural network nor any of the augmenting neural networks have been trained to perform the task.

The subject matter described in this specification can be implemented in particular embodiments so as to realize one or more of the following advantages.

Foundation models, e.g., large models with billions of parameters which have been trained on large corpora of data, have demonstrated non-trivial skills in a variety of domains. Examples of large foundation models include large language models (LLMs). However, due to their monolithic structure, it is challenging and expensive to augment them or impart new skills. In other words, it may be impractical to fine-tune a large base neural network to perform well on a new task if only a small number of training examples are available for the new task given the large number of parameters of the large model. Alternatively, fine-tuning may be prohibitively computationally expensive or require more training examples than are available for a given task due to the large number of parameters of the large model. Moreover, fine-tuning may degrade the existing capabilities of the large model.

The techniques described in this specification, on the other hand, provide an efficient and practical composition of a base neural network with more specific models (“augmenting neural networks”) to enable newer capabilities. In particular, the described techniques introduce cross-attention between models to compose their representations and enable new capabilities.

The described techniques allow for scaling-up LLMs on new tasks by ‘re-using’ existing LLMs along with a small number of additional parameters and data. Moreover, the existing model weights are kept intact, and hence the existing capabilities of the base neural network are preserved.

Moreover, the described techniques do not re-train either the augmenting neural network(s) or the base neural networks prior to using them as part of the composing neural network to perform the one or more tasks. Instead, the described techniques can train only the learned transformation and the cross-attention mechanism for each particular base layer block on training data for the one or more tasks. Thus, the described techniques can adapt the composing neural network to perform the one or more tasks in a very parameter-efficient manner and even if there is only a limited amount of training data for the one or more tasks available.

In other words, the described techniques allow a large base neural network, e.g., a foundation model, e.g., an LLM with billions of parameters, to be effectively adapted to improve the performance of the large base neural network on a new, specialized task in a manner that (i) does not degrade the performance of the large base neural network on tasks on which it already performs well, (ii) adds only a small number of additional parameters, and (iii) requires only a small number of training examples for the new task. This is done by composing the base neural network with one or more augmenting neural networks through cross-attention to generate a composed neural network that performs the new task.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF DRAWINGS

FIG. 1 shows an example composed neural network system.

FIG. 2 shows an example of different composed neural networks.

FIG. 3 is a flow diagram of an example process for generating an output sequence.

FIG. 4 is a flow diagram of an example process for augmenting the output of a particular base layer block.

FIG. 5 is a flow diagram of an example process for training the composed neural network system.

FIG. 6 shows an example of the performance of the described techniques.

Like reference numbers and designations in the various drawings indicate like elements.

### DETAILED DESCRIPTION

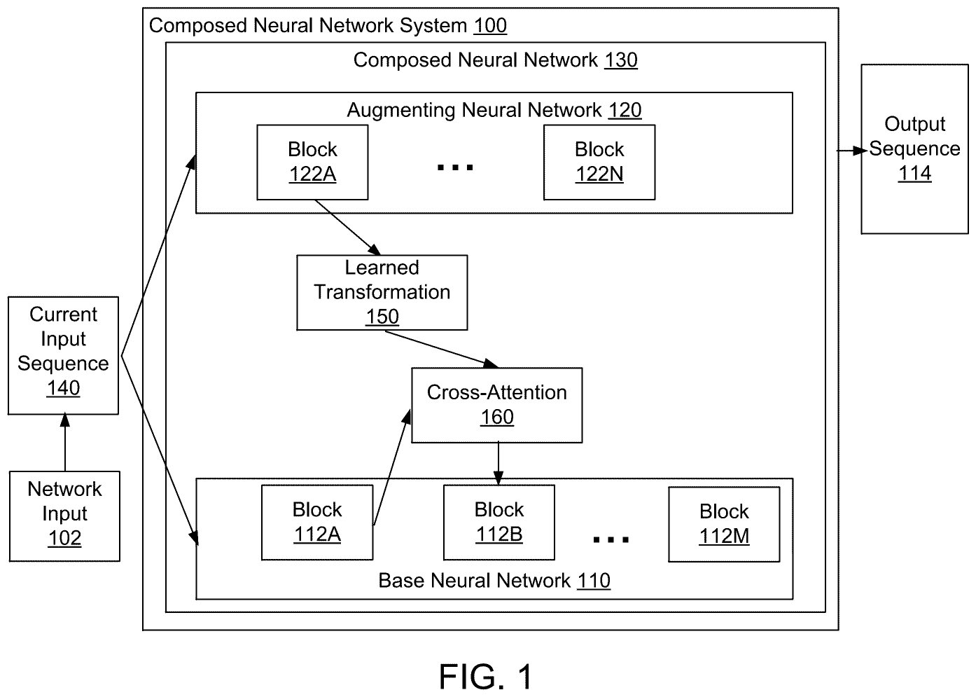

FIG. 1 shows an example composed neural network system 100. The composed neural network system 100 is an example of a system implemented as computer programs on one or more computers in one or more locations, in which the systems, components, and techniques described below can be implemented.

The system 100 performs a task by augmenting a base neural network 110 with one or more augmenting neural networks 120.

That is, while only a single augmenting neural network 120 is shown in FIG. 1 for ease of illustration, the system 100 can augment the base neural network 110 with any number of augmenting neural networks 120.

In other words, the system 100 “composes” multiple neural networks to generate a composed neural network 130 that can be used to perform one or more tasks, even if the base neural network 110 has not been trained to perform one or more of the tasks. In some cases, the composed neural network 130 can be used to effectively perform a task even if neither the base neural network 110 nor any of the augmenting neural networks 120 have been trained to perform the task.

Generally, the base neural network 110 is a generative neural network that auto-regressively generates sequence of output tokens. The neural network 110 can be referred to as an auto-regressive neural network, i.e., because the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token. As one example, the base neural network 110 can be a large language model neural network (LLM).

Each augmenting neural network 120 can also be a respective language model neural network, but may be smaller in size, i.e., have fewer parameters, than the base neural network 110. For example, each augmenting neural network 120 can include fewer layer blocks than the base neural network 110, can have a smaller model dimension than the base neural network 110 (where the model dimension refers to the dimensions of the hidden states processed by each of the layer blocks), or both.

Examples of architectures of the base and augmenting neural networks are described in more detail below.

Generally, the one or more tasks can be any tasks that require generating an output sequence 114 that includes a respective output token at each of multiple output positions. Examples of such tasks include computer code generation or editing tasks, text generation or editing tasks, image understanding tasks, audio generation tasks, and so on. For example, the output sequence can be computer code, can be natural language text, or a different sequence of tokens from a vocabulary of tokens. The input to the neural network 130 can include, e.g., a sequence of natural language text, a sequence of computer code, a sequence of audio, an image, or some combination the above.

Example tasks that the neural network 130 can perform will be described in more detail below.

To generate an output sequence 114 that includes a respective output token at each of multiple output positions using the composed neural network 130, the system 100 can perform the following operations for each of a plurality of the output positions. For example, the system can perform the described operations for each output position or for only a proper subset of the output positions.

The system 100 can identify a current input sequence 140 of tokens for the output position. Generally, the current input sequence 140 can include the output tokens that precede the output position in the output sequence 114. When the task requires generating the output sequence 114 conditioned on a network input 102, the current input sequence 140 can also include one or more tokens representing the network input 102. Examples of inputs for various tasks are provided in more detail below.

The system processes the current input sequence 140 using an augmenting neural network 120.

Generally, the augmenting neural network 120 includes a plurality of “augmenting” layer blocks 122A-N that each receive as input a respective input augmenting hidden state for each token in the current input sequence and process the respective input augmenting hidden states for each of the tokens in the current input sequence to generate a respective output augmenting hidden state for each of the tokens in the current input sequence.

A “layer block” as used in this specification is a collection of one or more neural network layers.

When the augmenting neural network 120 is a language model neural network as described above, the layer blocks 122 can each include a self-attention layer, e.g., a causally masked self-attention layer.

The system 100 processes the current input sequence 140 using the base neural network 110.

The base neural network 110 includes a plurality of base layer blocks 112A-M that each receive as input a respective input base hidden state for each token in the current input sequence and process the respective input base hidden states for each of the tokens in the current input sequence to generate a respective output base hidden state for each of the tokens in the current input sequence. When the base neural network 110 is a language model neural network as described above, the layer blocks 112 can each include a self-attention layer, e.g., a causally masked self-attention layer.

As part of the processing, for a particular base layer block 112, the system obtains the respective output base hidden states for each of the tokens in the current input sequence generated by the particular base layer block 112 and obtains the respective output augmenting hidden states for each of the tokens in the current input sequence generated by a particular augmenting layer block 122 of the augmenting neural network 120 that corresponds to the particular base layer block. That is, the particular base layer block 112 has a respective corresponding layer block 122 within each augmenting neural network 120.

The system 100 then generates a respective transformed augmenting hidden state for each of the tokens in the current input sequence by applying a learned transformation 150 to the respective output augmenting hidden states for each of the tokens in the current input sequence. Generally, the learned transformation 150 projects each augmenting hidden state to have the same dimensionality as the output base hidden states.

The system 100 generates a respective updated output base hidden state for each of the tokens in the current input sequence. As part of this, the system 100 performs cross-attention 160 between (i) the respective output base hidden states for each of the tokens in the current input sequence generated by the particular base layer block 112 and (ii) the respective transformed augmenting hidden state for each of the tokens in the current input sequence.

The system 100 then provides the respective updated output base hidden states for the tokens in the current input sequence as the respective input base hidden states for a base layer block 112 that follows the particular base layer block 112 in the base neural network 110.

That is, were the base neural network 110 not part of the composed neural network 130, the system 100 would provide the output base hidden states as the respective input base hidden states for the base layer block 112B that follows the particular base layer block 112A in the base neural network 110. Instead, the system 100 incorporates information from the corresponding augmenting hidden states generated by the augmenting neural network 120 and provides the resulting updated output base hidden states as the respective input base hidden states for the base layer block 112B.

The system 100 then processes at least the respective output base hidden state for the last token in the current input sequence 120 generated by the last base layer block 112 to select the output token at the output position.

For example, the system 100 can process the output base hidden state using an output subnetwork of the base neural network 110. For example, the system 100 can process the output base hidden state using the output subnetwork to generate a score distribution, e.g., a probability distribution or a logit distribution, over a vocabulary of tokens and then select a token using the score distribution, e.g., by greedily selecting or by sampling. For example, the output subnetwork can include one or more output neural network layers, e.g., fully-connected layers, followed by a softmax layer.

As another example, the composed neural network 130 can include an aggregation output block that processes the respective output base hidden state for the last token in the current input sequence 112 and one or more other hidden states to select the output token at the output position.

For example the aggregation output block can process the respective output base hidden state for the last token in the current input sequence 120 generated by the last base layer block 112 and the respective output augmenting hidden state for the last token in the current input sequence 120 generated by the last augmenting layer block 122 to generate a score distribution, e.g., a probability distribution or a logit distribution, over a vocabulary of tokens and then the system 100 can select a token using the score distribution, e.g., by greedily selecting or by sampling. For example, the aggregation output block can include one or more output neural network layers, e.g., fully-connected layers, followed by a softmax layer.

While the above describes that there is a single “particular” base layer block 112 that has a single corresponding augmenting layer block 122, more generally, there can be multiple base layer blocks 112 that have each been designated as “particular” base layer blocks 122 and that each have been assigned a corresponding augmenting layer block 112. When there are multiple particular base layer blocks 112, the system 110 can perform the above operations for each particular base layer block 112 when processing the current input sequence. As a particular example, in some cases, the particular base layer blocks 112 include the last base layer block in the base neural network 110, so that the hidden states generated by the last base layer block are updated before being provided to the output subnetwork.

In some cases, the system does not re-train either the augmenting neural network(s) 120 or the base neural networks 110 prior to using them as part of the composed neural network 130 to perform the one or more tasks.

Instead, the system 100 can train only the learned transformation 150 and the cross-attention mechanism 160 for each particular base layer block 112 on training data for the one or more tasks. Thus, the system 100 can adapt the composed neural network 130 to perform the one or more tasks in a very parameter-efficient manner and even if there is only a limited amount of training data for the one or more tasks available.

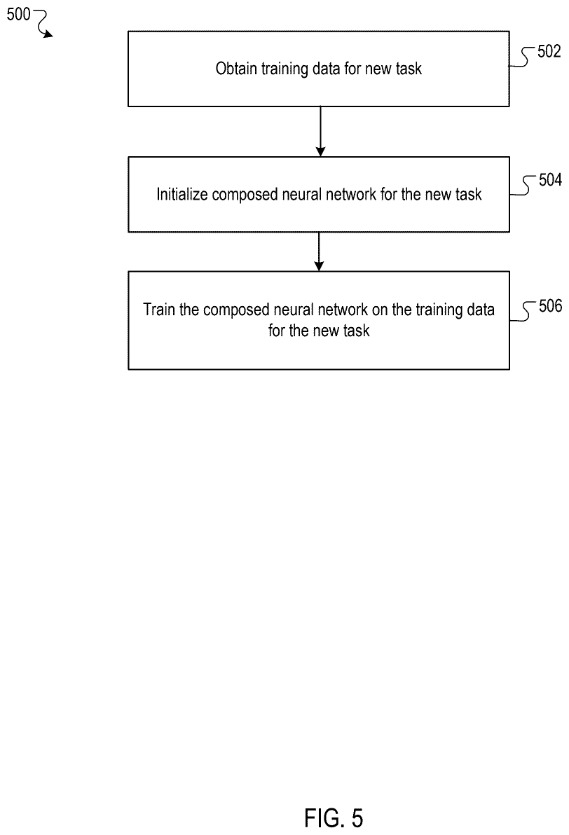

Training the composed neural network is described in more detail below with reference to FIG. 5.

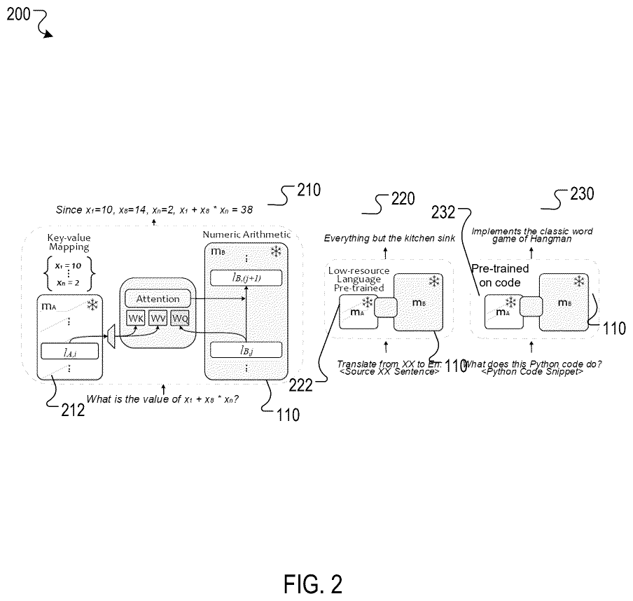

FIG. 2 shows an example 200 of different composed neural networks.

In particular, FIG. 2 shows how the same base neural network 110 can be augmented with different augmenting neural networks to improve the performance of the base neural network 110 on a variety of tasks.

For example, FIG. 2 shows an example composed neural network 210. In the example composed neural network 210, a “generalist” base neural network 110 is augmented with a smaller augmented neural network 212 that has been trained to specialize in key-value mapping capabilities. In particular, the augmented neural network 212 has been trained to encode certain key-value pairs, e.g., x1=10, in the parameters (weights) of the augmented neural network 212.

As a result, because the base neural network 110 has numeric arithmetic capabilities, the composed neural network 210 is able to effectively perform a task that requires performing arithmetic on keys by referring to the corresponding values, even though the base neural network 110 does not have any access to any of the key-value mappings and the augmented neural network 212 has not been trained to perform arithmetic.

As another example, FIG. 2 shows an example composed neural network 220. In the example composed neural network 210, the “generalist” base neural network 110 is augmented with a smaller augmented neural network 222 that has been trained to specialize in low-resource languages. In particular, the augmented neural network 222 has been trained to interpret and generate text in low-resource languages that are either not present in the training data of the base neural network 110 or make up only a very small percentage of the text in the training data. As a result, because the base neural network 110 has general language translation capabilities, the composed neural network 220 is able to effectively translate to and from the low-resource languages.

As another example, FIG. 2 shows an example composed neural network 230. In the example composed neural network 210, the “generalist” base neural network 110 is augmented with a smaller augmented neural network 232 that has been trained to process computer code. As a result, because the base neural network 110 has general language understanding capabilities, the composed neural network 230 is able to effectively answer queries relating to code snippets.

Thus, as can be seen from the example 200, the same base neural network 110 can be augmented with different augmenting neural networks for different new tasks. The resulting composed neural networks can be used to perform the respective new tasks. Moreover, because the base neural network 110 is not further trained as part of generating the composed neural networks, the existing capabilities of the base neural network 110 are not degraded and the same base neural network 110 can be included in multiple different composed neural networks and can also be used separately on tasks where the existing capabilities suffice.

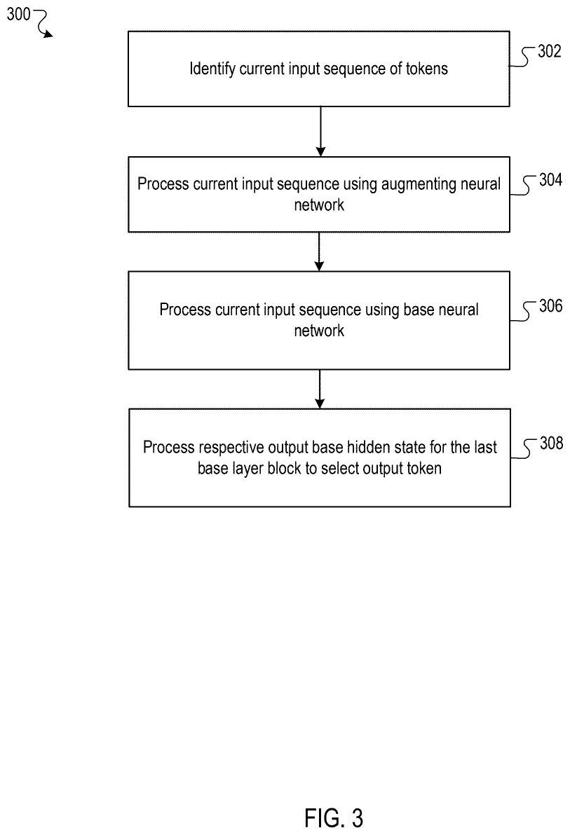

FIG. 3 is a flow diagram of an example process 300 for generating an output sequence. For convenience, the process 300 will be described as being performed by a system of one or more computers located in one or more locations. For example, a composed neural network system, e.g., the composed neural network system 100 of FIG. 1, appropriately programmed in accordance with this specification, can perform the process 300.

In particular, by repeatedly performing the process 300, the system generates an output sequence that has a respective output token at each of a plurality of output positions. For example, the system can auto-regressively generate the output sequence by repeatedly performing iterations the process 300 to add a new output token to the output sequence at each iteration.

In some cases, the system performs an iteration of the process 300 for each of the output positions. In some other cases, the system performs the process 300 for a proper subset of the output positions, e.g., every other output position, every third output position, and so on. In these cases, for positions that are not in the proper subset, the system can generate the output using only the base neural network.

The system identifies a current input sequence of tokens for the output position (step 302). The current input sequence includes the output tokens that precede the output position in the output sequence. When the output sequence is conditioned on a network input, the current input sequence also includes one or more tokens representing the network input.

The system processes the current input sequence using an augmenting neural network (step 304). As described above, the augmenting neural network has a plurality of augmenting layer blocks that each receive as input a respective input augmenting hidden state for each token in the current input sequence and process the respective input augmenting hidden states for each of the tokens in the current input sequence to generate a respective output augmenting hidden state for each of the tokens in the current input sequence.

The system processes the current input sequence using a base neural network (step 306). The base neural network has a plurality of base layer blocks that each receive as input a respective input base hidden state for each token in the current input sequence and process the respective input base hidden states for each of the tokens in the current input sequence to generate a respective output base hidden state for each of the tokens in the current input sequence.

As part of this, the system augments the output of one or more base layer blocks that have been designated as particular base layer blocks using the output of a corresponding augmenting base layer block. That is, each particular base layer block has a different corresponding augmenting layer block within the augmenting neural network.

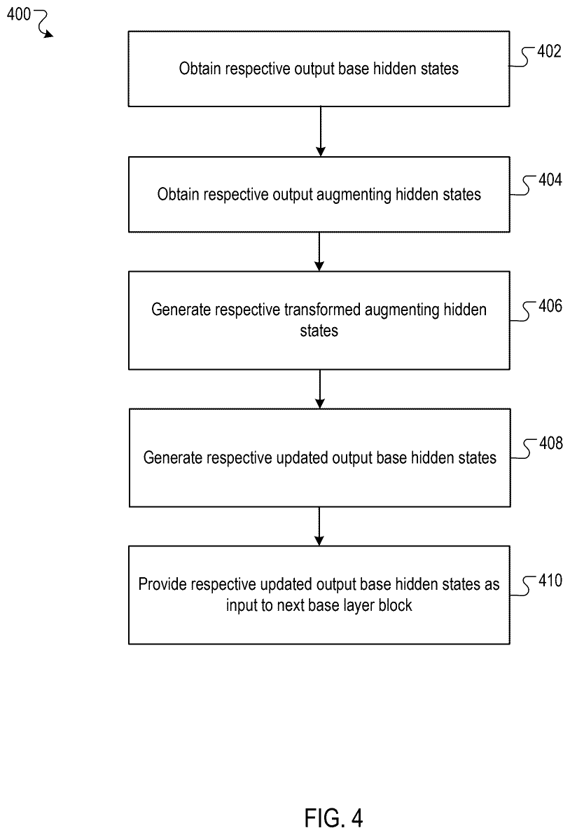

This augmenting will be described below with reference to FIG. 4.

The system processes at least the respective output base hidden state for the last token in the current input sequence generated by the last base layer block to select the output token at the output position (step 308). For example, the system can process the respective output base hidden state for the last token in the current input sequence using an output subnetwork to generate a probability distribution over a vocabulary of tokens and then select the output token at the output position using the probability distribution, e.g., by sampling from the distribution or by greedily selecting the token with the highest probability. As another example, the system can process the respective output base hidden state for the last token in the current input sequence generated by the last base layer block and one or more other output hidden states, e.g., one or more output hidden states from one or more of the augmenting neural networks, to select the output token.

FIG. 4 is a flow diagram of an example process 400 for augmenting the output of a particular base layer block. For convenience, the process 400 will be described as being performed by a system of one or more computers located in one or more locations. For example, a composed neural network system, e.g., the composed neural network system 100 of FIG. 1, appropriately programmed in accordance with this specification, can perform the process 400.

The system can perform the process 400 for each particular base layer block, i.e., each base layer block that is augmented with an output from one or more layer blocks of one or more augmenting neural networks.

The system obtains the respective output base hidden states for each of the tokens in the current input sequence generated by the particular base layer block (step 402).

The system obtains the respective output augmenting hidden states for each of the tokens in the current input sequence generated by a particular augmenting layer block of the augmenting neural network that corresponds to the particular base layer block (step 404).

The system generates a respective transformed augmenting hidden state for each of the tokens in the current input sequence by applying a learned transformation to the respective output augmenting hidden states for each of the tokens in the current input sequence (step 406).

The learned transformation can generally be any appropriate learned transformation, i.e., a transformation that has parameters that have been learned during training. As a particular example, the learned transformation can be a learned linear transformation.

In some implementations, when there are multiple augmenting layer blocks that correspond to different particular base layer blocks, the system can apply the same learned transformation to the outputs of each augmenting layer block. In some other implementations, the system can learn a different learned transformation for each layer augmenting layer block. For example, the respective output base hidden states can each have a first dimensionality, the respective output augmented hidden states each have a second, different dimensionality, and the learned transformation can map each output augmented hidden state from the second dimensionality to the first dimensionality. In some cases, because the base neural network is a larger neural network with a larger model dimension, the first dimensionality is larger than the second dimensionality.

As a particular example, the application of the learned transformation can be represented as:

$${f}_{proj} ( {A}_{} ) ← \{ {f}_{proj} ( {H}_{A 1} ) , {f}_{proj} ( {H}_{A 2} ) , … , {f}_{proj} ( {H}_{A {n}_{A}} ) \}$$

where n_{A} is the number of layer blocks in the augmenting neural network that have a corresponding layer block in the base neural network, [symbol] represents the set of augmenting layer blocks that each have a corresponding particular base layer block, fₚᵣₒⱼ represents the learned transformation, and H_{A} is the output hidden state for the A-th augmenting layer block.

The system generates a respective updated output base hidden state for each of the tokens in the current input sequence (step 408).

As part of this, the system performs cross-attention between (i) the respective output base hidden states for each of the tokens in the current input sequence generated by the particular base layer block and (ii) the respective transformed augmenting hidden state for each of the tokens in the current input sequence.

For example, to perform the cross-attention, the system can (i) generate a set of values from the respective transformed augmenting hidden states that includes a respective value for each of the transformed augmenting hidden states; (ii) generate a set of keys from the respective transformed augmenting hidden states that includes a respective key for each of the transformed augmenting hidden states; (iii) generate a set of queries from the respective output base hidden states that includes a respective query for each of the output base hidden states; and (iv) apply query-key-value attention between the sets of queries, keys, and values to generate a respective updated query for each of the output base hidden states.

The system can perform steps (i)-(iv) for each of one or more attention heads of the cross-attention mechanism. When the cross-attention mechanism has multiple heads, the system can then combine the respective updated queries for each of the output base hidden states to generate the final outputs of the self-attention.

When there are NH cross attention heads, this application of the cross-attention mechanism f_{cross} can be represented as:

$${f}_{cross} ( {f}_{proj} ( {H}_{Ai} ) , {H}_{Bj} ) = {Concat}_{\cdot k} ( {head}_{k} ) {W}^{O} ∀ k ∈ {N}_{H}$$

$$where , {head}_{k} = Attn . ( {Q}_{B} , {K}_{A} , {V}_{A} ) ,$$

$$and , {Q}_{B} = {H}_{Bj} {W}_{k}^{Q} ,$$

$${K}_{A} , {V}_{A} = {f}_{proj} ( {H}_{Ai} ) {W}_{k}^{K} , {f}_{proj} ( {H}_{Ai} ) {W}_{k}^{V}$$

where H_{B} is the output hidden state for the B-th base layer block, Concatₖ represents concatenation, Attn(Q, K, V) represents a query-key-value attention mechanism applied to queries Q, keys K, and values V, and the W matrices are respective learned weight matrices of the cross-attention mechanism.

In some implementations, the system uses the outputs of the cross-attention as the respective updated output base hidden state for each of the tokens.

In some other implementations, the system applies one or more additional operations to the outputs of the cross-attention to generate the respective updated output base hidden state for each of the tokens. For example, the system can apply a residual connection between the outputs of the cross-attention and the respective output base hidden states to generate the respective updated output base hidden state for each of the tokens. In this case, the update base hidden state H_{A⊕Bj} can be represented as:

$${H}_{A ⊕ Bj} = {H}_{Bj} + {f}_{cross} ( {f}_{proj} ( {H}_{Ai} ) , {H}_{Bj} )$$

Thus, the parameters of the composed neural network include, in addition to the parameters of the base neural network and the augmenting neural network(s) and for each particular base layer block, (i) parameters of the learned transformation and (ii) parameters of the cross-attention, e.g., the query, key, and value matrices.

The system then provides the respective updated output base hidden states for the tokens in the current input sequence as the respective input base hidden states for a base layer block that follows the particular base layer block in the base neural network (step 410).

As described above, while only a single augmenting neural network is described above with reference to FIG. 4, the system can make use of multiple different augmenting neural networks. Each augmenting neural network has a respective learned transformation that is applied to the output hidden states of that augmenting neural networks and respective cross-attention mechanisms for each layer block of the augmenting neural network that has a corresponding base layer block.

In some implementations, each of the multiple augmenting neural networks have different corresponding base layer blocks, so any given particular base layer block has only a single corresponding augmenting layer block from a single augmenting neural network.

In some other implementations, a given particular base layer block can have multiple different corresponding augmenting layer blocks from multiple different augmenting neural networks. In these implementations, the system can arrange the cross-attention mechanisms for the multiple different corresponding augmenting layer blocks in sequence, so that the first cross-attention mechanism updates the output base hidden state generated by the particular base layer block and each subsequent cross-attention mechanism updates the base hidden state after being updated by the preceding cross-attention mechanism.

Similarly, in some cases, the system can consolidate multiple different composed neural networks, so that the output at any given output position is generated by composing outputs generated by each of the multiple composed neural networks. In this example, each composed neural network can differ from each other composed neural network in that (i) the base neural networks are different, (ii) one or more of the augmenting neural networks are different, or (iii) both. For example, the aggregation block describes above can process the output base hidden state for the last token in the current input sequence generated by the last base layer of each composed neural network to select the output token as described above.

FIG. 5 is a flow diagram of an example process 500 for training a composed neural network. For convenience, the process 500 will be described as being performed by a system of one or more computers located in one or more locations. For example, a composed neural network system, e.g., the composed neural network system 100 of FIG. 1, appropriately programmed in accordance with this specification, can perform the process 500.

The system obtains training data for a new task (step 502). For example, the training data can include multiple training examples, each training example including a network input for the new task and, in some cases, a target output for the new task.

The system initializes a composed neural network for the new task (step 504). The composed neural network includes a base neural network that has already been trained on one or more first tasks and one or more augmenting neural networks that have each been trained on one or more respective second tasks. Generally, so that the augmenting neural networks can improve the performance of the base neural network, the respective second tasks are different from the one or more first tasks. The base and augmenting neural networks can have been trained on the first and second tasks, respectively, using any appropriate objective function for the tasks, e.g., one or more of unsupervised learning through next token prediction, supervised training, reinforcement learning, and so on.

The composed neural network also includes, for each of one or more particular base layer blocks of the base neural network, (i) parameters of a respective learned transformation and (ii) parameters of a respective cross-attention mechanism. As described above, in some cases the respective learned transformations are the same for each particular base layer block (and therefore for each corresponding augmenting layer blocks), while in other cases the learned transformations can be different.

The system trains the composed neural network on the training data for the new task (step 506). In particular, the system trains the composed neural network to adjust the parameters of the respective learned transformation(s) and the parameters of the respective cross-attention mechanism(s) while holding the parameters of the base neural network and the augmenting neural network(s) fixed to the pre-trained values determined by the training on the first and second tasks, respectively.

Thus, the system does not re-train either the augmenting neural network(s) or the base neural networks prior to using them as part of the composing neural network to perform the one or more tasks. Instead, the system can train only the learned transformation and the cross-attention mechanism for each particular base layer block on training data for the one or more tasks. Thus, the system can adapt the composing neural network to perform the one or more tasks in a very parameter-efficient manner and even if there is only a limited amount of training data for the one or more tasks available. In other words, because the respective learned transformation(s) and the respective cross-attention mechanism(s) have relatively few parameters relative to the number of parameters of the base neural network and the augmenting neural networks, the system can perform the training in a much more computationally efficient manner than if the system were to fine-tune the base neural network, the augmenting neural network(s), or both.

The system can perform the training of the composed neural network on the training data for the new task using an appropriate objective, e.g., through next token prediction, e.g., negative log likelihoods, or through reinforcement learning, e.g., using rewards determined for outputs generated by the composed neural network. When training through reinforcement learning, the training examples for the new task may not include target outputs and the system can score generated outputs using a reward model for the new task.

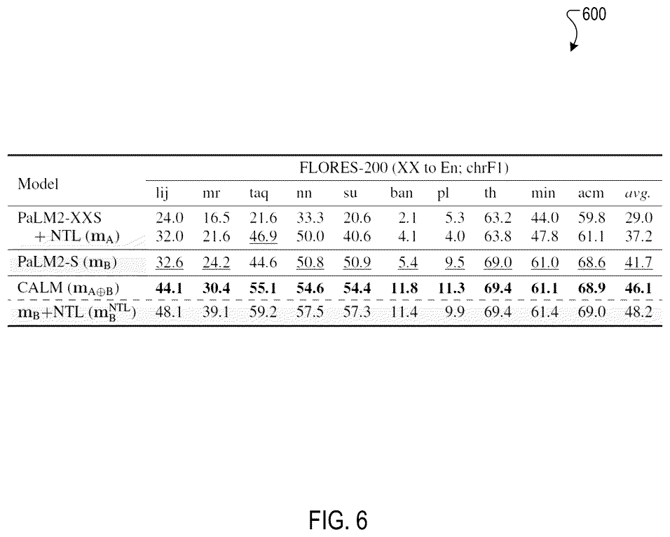

FIG. 6 shows an example 600 of the performance of the described techniques. In particular, the example 600 shows translation performance for XX to English direction on the FLORES-200 dataset (Costajussà, et al., 2022). More specifically, the example shows results for a subset of 10 low-resource languages. Note that the composed model mA⊕B significantly outperforms both the augmenting model mA and the base model mB. On the complete language list, mA⊕B outperforms both the underlying models for 175 of 192 languages. mNTL_B represents a skyline where mB has been further pre-trained on the task as shown in the example 600, the composed model achieves similar performance for a tiny fraction of the training cost.

Similar performance gains can be observed on any of a number of tasks, e.g., arithmetic, coding, and so on.

In this specification, a “token” is a vector of numeric values that has a fixed dimensionality.

A token can be a discrete token, e.g., a one-hot representation of an input or output from a corresponding vocabulary or a continuous token, e.g., a continuous representation of at least a portion of a corresponding input or output.

A description of one example configuration of the base neural network now follows.

For example, the base neural network can be an auto-regressive generative neural network that generates each token in the output sequence conditioned on the preceding tokens in the output sequence and at least some of the tokens in the input sequence.

For example, the base neural network can be a language model neural network, e.g., a large language model (“LLM”) that is configured to process an input sequence of tokens from a vocabulary of tokens to generate an output sequence of tokens from the vocabulary.

More generally, the base neural network can be any appropriate neural network that receives an input sequence made up of tokens selected from a vocabulary and auto-regressively generates an output sequence made up of tokens from the vocabulary. For example, the base neural network can be a Transformer-based language model neural network or a recurrent neural network-based language model neural network.

In some situations, the base neural network can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the base neural network can process the current input sequence to generate a score distribution (e.g., a probability distribution) that assigns a respective score, e.g., a respective probability, to each token in the vocabulary of tokens. The base neural network can then select, as the particular token, a token from the vocabulary using the score distribution. For example, the base neural network can greedily select the highest-scoring token or can sample, e.g., using nucleus sampling or another sampling technique, a token from the distribution.

As a particular example, the base neural network can be an auto-regressive Transformer-based neural network that includes (i) a plurality of attention blocks, at least some of which apply a self-attention operation and (ii) an output subnetwork that processes an output of the last attention block to generate the score distribution.

The base neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Gemini (described in arXiv: 2403.05530), Gemma (described in arXiv: 2403.08295), and PaliGemma (described in arXiv: 2412.03555).

Generally, the output sequence of output tokens is used to generate the output for the task that the neural network 110 is performing.

For example, the output sequence can be mapped to a text sequence and the text sequence can be provided as the output.

When the output sequence includes tokens representing other modalities other than text, those tokens can be mapped to outputs of the corresponding modality by a corresponding decoder and then provided, e.g., along with a text sequence also specified by the output sequence, as the output.

Some examples of tasks that the composed neural network can perform will now be described.

The neural network 130 can be configured to perform any kind of machine learning task, i.e., can be configured to receive any kind of input sequence and to generate any kind of score, classification, or regression output based on the input sequence.

Some examples of machine learning tasks that a neural network 130 when implemented using one of the architectures described below or other known architectures can be configured to perform now follow.

In any of the implementations below, the neural network 130 may be deployed as part of a chat bot, dialogue agent, or other software tool that receives inputs from users and provides outputs in response to the received input, e.g., as part of a conversation or dialogue. In these implementations, the input sequences received by the neural network 130 are (generated from) user inputs and the output sequences generated by the neural network can be used to generate responses to the user inputs.

In implementations the neural network 130 may be configured as, or include a generative (large) language model or a multi-modal model, e.g., a visual and language model, to perform these example machine learning tasks.

In some cases, the neural network 130 is a neural network that is configured to perform an image processing task, i.e., receive an input image and to process the input image to generate a network output for the input image. For example, the input sequence may comprise tokens representing pixel values for pixels in regions or patches of the image. For example, the task may be image classification and the output generated by the neural network 130 for a given image may be scores for each of a set of object categories, with each score representing an estimated likelihood that the image contains an image of an object belonging to the category. As another example, the task can be image embedding generation and the output generated by the neural network 130 can be a numeric embedding of the input image. As yet another example, the task can be object detection and the output generated by the neural network 130 can identify locations in the input image at which particular types of objects are depicted. As yet another example, the task can be image segmentation and the output generated by the neural network 130 can assign each pixel of the input image to a category from a set of categories. In some other cases, the neural network 130 is a neural network that is configured to perform an image generation task, where the input is a conditioning input, and the output is a sequence of intensity value inputs for the pixels of an image.

As one example, the task may be a neural machine translation task. For example, if the input to the neural network 130 is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, word pieces, or characters of the first language, and the vocabulary for the output tokens may be words, word pieces, or characters of the other language. As a particular example, the task may be a multi-lingual machine translation task, where a single neural network is configured to translate between multiple different source language-target language pairs. In this example, the source language text may be augmented with an identifier that indicates the target language into which the neural network 130 should translate the source language text.

Some implementations may be used for automatic code generation. For example, the input tokens may represent words, word pieces, or characters in a first natural language and the output tokens may represent instructions in a computer programming or markup language, or instructions for controlling an application program to perform a task, e.g., build a data item such as an image or web page.

As another example, the task may be an audio processing task. For example, if the input to the neural network 130 is a sequence representing a spoken utterance, the output generated by the neural network may be a score for each of a set of pieces of text, each score representing an estimated likelihood that the piece of text is the correct transcript for the utterance, e.g., a speech to text task. As another example, if the input sequence to the neural network 130 is a sequence representing a spoken utterance, the network output generated by the neural network 130 can indicate whether a particular word or phrase (“hotword”) was spoken in the utterance. As another example, if the input sequence to the neural network 130 is a sequence representing a spoken utterance, the network output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input sequence is a sequence of text, and the network output is another sequence of text, e.g., a completion of the input sequence of text, a response to a question posed in the input sequence 105, or a sequence of text that is about a topic specified by the first sequence of text. As another example, the input to the text generation task can be an input other than text, e.g., an image, and the network output sequence can be text that describes the input.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network. In some complementary implementations the input sequence represents compressed data, and the network output sequence represents a decompressed version of the data, e.g., image data, text data, audio data, or any other type of data.

As another example, the task can be an agent control task, where the input is a sequence of observations or other data characterizing states of an environment, and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example, a system 100 implementing the neural network 130 may be used to select actions in the simulated environment during training or evaluation of the system 100 and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system 100 may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

In some implementations, as described above, the agent may not include a human being (e.g., it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system 100 implementing the neural network 130 may output to the human user, via the digital assistant, instructions for actions for the user to perform at each of a plurality of time steps. The instructions may for example be generated in the form of natural language (transmitted as sound and/or text on a screen) based on actions chosen by the system. The system 100 chooses the actions such that they contribute to performing a task. A monitoring system (e.g., a video camera system) may be provided for monitoring the action (if any) which the user actually performs at each time step, in case (e.g., due to human error) it is different from the action which the system 100 instructed the user to perform. Using the monitoring system, the system 100 can determine whether the task has been completed. The system 100 may identify actions which the user performs incorrectly with more than a certain probability. If so, when the system 100 instructs the user to perform such an identified action, the system 100 may warn the user to be careful. Alternatively, or additionally, the system 100 may learn not to instruct the user to perform the identified actions, i.e., ones which the user is likely to perform incorrectly.

More generally, the digital assistant instructing the user may comprise receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This may be done using natural language, e.g., on a display and/or using a speech synthesis subsystem of the digital assistant. Visual, e.g., video, and/or audio observations of the user performing the task may be captured, e.g., using the digital assistant. A system as described above may then be used to determine whether the user has successfully achieved the task, e.g., step or sub-task, i.e., from the answer as previously described. If there are further tasks to be completed the digital assistant may then, in response, progress to the next task (if any) of the series of tasks, e.g., by outputting an indication of the next task to be performed. In this way the user may be led step-by-step through a series of tasks to perform an overall task. During the training of the neural network 130, training rewards may be generated, e.g., from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as Sparrow (Glaese, et al., arXiv: 2209.14375) or Chinchilla (Hoffmann, et al., arXiv: 2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g., to stop capturing observations.

As another example, the task can be a genomics task, where the input sequence is a sequence representing a fragment of a DNA sequence or other molecule sequence and the network output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system 100 is configured to perform multiple different individual machine learning tasks, e.g., two or more of the machine learning tasks mentioned above. For example, the system 100 can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of (i) text data representing text in a natural language and (ii) pixels of an image or of video or audio data representing values of an audio waveform. Optionally, but not necessarily, the different types of data may represent the same or overlapping objects using the different modalities (types), and when processing multi-modal data, the data may be mapped into a common embedding space.

As a particular example, the task is a multi-modal processing task that requires processing both text and image inputs, so that the neural network 130 includes both a computer vision neural network and a text processing neural network. That is, the target network output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

As some further examples a multi-modal processing task can involve processing a text input including a sequence of text or audio data representing values of an audio waveform, e.g., instantaneous amplitude data or time-frequency domain data, or an image or video (or encoded versions of these inputs) to generate the network output. The network output may include any form of output appropriate to the task performed. For example, the network output may include text in a natural or computer language that defines a result of the task, e.g., for tasks such as image captioning, video or audio question answering (answering a natural language question about a visual or audio input), or object detection or instance segmentation. For example in a video or audio question answering task the question can define an information content extraction task, to extract information from the content of the video or audio, or the question can define a reasoning task such as a predictive reasoning task (e.g., “what would happen next?”), a counterfactual reasoning task (e.g., “what would happen if . . . ?”), or a causal reasoning task (e.g., “why did X happen?”). The network output can provide an answer in any convenient form, e.g., tokens representing natural language. An input to the system may be obtained from a sensor sensing the real world, e.g., a condition or characteristic of the real world. For example, the video or audio may be captured from the real-world. The network output can then provide an answer, e.g., in natural language, to a question asked about the real-world input.

Also, or instead the network output may include data defining an image, video or audio object, e.g., as specified by the input (e.g., by a natural language description of one or more characteristics of the object), e.g., in a generative task. As a further alternative the network output may include non-textual action selection data for selecting an action to be performed by an agent controlled by the network output, e.g., as described above, e.g., in response to an input that includes a natural language description of a physical or other task to be performed by the agent. As another example the network output may also or instead define an intermediate step to be performed during the task, e.g., a call to a software API for a software tool that is used when performing the task; the input may then receive an output from the software tool that is used to generate a final network output that performs the task.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example, detection or classification of an object or event may be improved when data of multiple different types (modalities) is processed.

More generally, the task to be performed by the neural network 130 can be specified by the input sequence. As a particular example, the input sequence can include a prompt or an instruction that specifies the task that is to be performed by the neural network 130. Optionally, in this example, the input sequence also includes context for performing the task. In general, in implementations of the described techniques the input data, e.g., text, audio, and/or an image or video, may be encoded into a sequence of input tokens in any convenient manner; and output tokens may be similarly decoded into text, audio, and/or image or video data according to the particular task or tasks to be performed.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method performed by one or more computers and for generating an output sequence that comprises a respective output token at each of a plurality of output positions, the method comprising, for each of a plurality of the output positions:
identifying a current input sequence of tokens for the output position, the current input sequence comprising the output tokens that precede the output position in the output sequence;
processing the current input sequence using an augmenting neural network, wherein the augmenting neural network comprises a plurality of augmenting layer blocks that each receive as input a respective input augmenting hidden state for each token in the current input sequence and process the respective input augmenting hidden states for each of the tokens in the current input sequence to generate a respective output augmenting hidden state for each of the tokens in the current input sequence;
processing the current input sequence using a base neural network, wherein the base neural network comprises a plurality of base layer blocks that each receive as input a respective input base hidden state for each token in the current input sequence and process the respective input base hidden states for each of the tokens in the current input sequence to generate a respective output base hidden state for each of the tokens in the current input sequence, the processing comprising, for a particular base layer block:
obtaining the respective output base hidden states for each of the tokens in the current input sequence generated by the particular base layer block;
obtaining the respective output augmenting hidden states for each of the tokens in the current input sequence generated by a particular augmenting layer block of the augmenting neural network that corresponds to the particular base layer block;
generating a respective transformed augmenting hidden state for each of the tokens in the current input sequence by applying a learned transformation to the respective output augmenting hidden states for each of the tokens in the current input sequence;
generating a respective updated output base hidden state for each of the tokens in the current input sequence, comprising: performing cross-attention between (i) the respective output base hidden states for each of the tokens in the current input sequence generated by the particular base layer block and (ii) the respective transformed augmenting hidden state for each of the tokens in the current input sequence; and
providing the respective updated output base hidden states for the tokens in the current input sequence as the respective input base hidden states for a base layer block that follows the particular base layer block in the base neural network; and
processing at least the respective output base hidden state for the last token in the current input sequence to select the output token at the output position.

2. The method of claim 1, wherein:
the output sequence is conditioned on a network input, and
the current input sequence comprises one or more tokens representing the network input.

3. The method of claim 1, wherein the respective output base hidden states each have a first dimensionality, the respective output augmented hidden states each have a second dimensionality, and the learned transformation maps each output augmented hidden state from the second dimensionality to the first dimensionality.

4. The method of claim 3, wherein the first dimensionality is larger than the second dimensionality.

5. The method of claim 1, wherein the learned transformation is a learned linear transformation.

6. The method of claim 1, wherein performing cross-attention between (i) the respective output base hidden states for each of the tokens in the current input sequence generated by the particular base layer block and (ii) the respective transformed augmenting hidden state for each of the tokens in the current input sequence comprises:
generating a set of values from the respective transformed augmenting hidden states that comprises a respective value for each of the transformed augmenting hidden states;
generating a set of keys from the respective transformed augmenting hidden states that comprises a respective key for each of the transformed augmenting hidden states;
generating a set of queries from the respective output base hidden states that comprises a respective query for each of the output base hidden states; and
applying query-key-value attention between the sets of queries, keys, and values to generate a respective updated query for each of the output base hidden states.

7. The method of claim 1, wherein:
the augmenting neural network is a neural network that has been trained to perform a first task; and
the base neural network is a neural network that has been trained to perform a second, different task.

8. The method of claim 1, wherein the output sequence is an output sequence for a third task, and wherein the linear transformation and parameters of the cross-attention have been learned on training data for the third task.

9. The method of claim 8, wherein neither the augmenting neural network nor the base neural network have been trained on the third task.

10. The method of claim 1, wherein the base layer blocks comprise one or more layer blocks that each apply respective self-attention operations as part of generating the respective output base hidden states for each of the tokens in the current input sequence.

11. The method of claim 1, wherein the augmenting layer blocks comprise one or more layer blocks that each apply respective self-attention operations as part of generating the respective output augmenting hidden states for each of the tokens in the current input sequence.

12. The method of claim 1, wherein a total number of base layer blocks within the base neural network is greater than a total number of augmenting layer blocks within the augmenting neural network.

13. A system comprising one or more computers and one or more storage devices storing instructions that when executed by the one or more computers cause the one more computers to perform operations for generating an output sequence that comprises a respective output token at each of a plurality of output positions, the operations comprising, for each of a plurality of the output positions:
identifying a current input sequence of tokens for the output position, the current input sequence comprising the output tokens that precede the output position in the output sequence;
processing the current input sequence using an augmenting neural network, wherein the augmenting neural network comprises a plurality of augmenting layer blocks that each receive as input a respective input augmenting hidden state for each token in the current input sequence and process the respective input augmenting hidden states for each of the tokens in the current input sequence to generate a respective output augmenting hidden state for each of the tokens in the current input sequence;
processing the current input sequence using a base neural network, wherein the base neural network comprises a plurality of base layer blocks that each receive as input a respective input base hidden state for each token in the current input sequence and process the respective input base hidden states for each of the tokens in the current input sequence to generate a respective output base hidden state for each of the tokens in the current input sequence, the processing comprising, for a particular base layer block:
obtaining the respective output base hidden states for each of the tokens in the current input sequence generated by the particular base layer block;
obtaining the respective output augmenting hidden states for each of the tokens in the current input sequence generated by a particular augmenting layer block of the augmenting neural network that corresponds to the particular base layer block;
generating a respective transformed augmenting hidden state for each of the tokens in the current input sequence by applying a learned transformation to the respective output augmenting hidden states for each of the tokens in the current input sequence;
generating a respective updated output base hidden state for each of the tokens in the current input sequence, comprising: performing cross-attention between (i) the respective output base hidden states for each of the tokens in the current input sequence generated by the particular base layer block and (ii) the respective transformed augmenting hidden state for each of the tokens in the current input sequence; and
providing the respective updated output base hidden states for the tokens in the current input sequence as the respective input base hidden states for a base layer block that follows the particular base layer block in the base neural network; and
processing at least the respective output base hidden state for the last token in the current input sequence to select the output token at the output position.

14. The system of claim 13, wherein:
the output sequence is conditioned on a network input, and
the current input sequence comprises one or more tokens representing the network input.

15. The system of claim 13, wherein the respective output base hidden states each have a first dimensionality, the respective output augmented hidden states each have a second dimensionality, and the learned transformation maps each output augmented hidden state from the second dimensionality to the first dimensionality.

16. The system of claim 15, wherein the first dimensionality is larger than the second dimensionality.

17. The system of claim 13, wherein the learned transformation is a learned linear transformation.

18. The system of claim 13, wherein performing cross-attention between (i) the respective output base hidden states for each of the tokens in the current input sequence generated by the particular base layer block and (ii) the respective transformed augmenting hidden state for each of the tokens in the current input sequence comprises:
generating a set of values from the respective transformed augmenting hidden states that comprises a respective value for each of the transformed augmenting hidden states;
generating a set of keys from the respective transformed augmenting hidden states that comprises a respective key for each of the transformed augmenting hidden states;
generating a set of queries from the respective output base hidden states that comprises a respective query for each of the output base hidden states; and
applying query-key-value attention between the sets of queries, keys, and values to generate a respective updated query for each of the output base hidden states.

19. The system of claim 13, wherein:
the augmenting neural network is a neural network that has been trained to perform a first task; and
the base neural network is a neural network that has been trained to perform a second, different task.

20. One or more non-transitory computer storage media storing instructions that when executed by one or more computers cause the one more computers to perform operations for generating an output sequence that comprises a respective output token at each of a plurality of output positions, the operations comprising, for each of a plurality of the output positions:
identifying a current input sequence of tokens for the output position, the current input sequence comprising the output tokens that precede the output position in the output sequence;
processing the current input sequence using an augmenting neural network, wherein the augmenting neural network comprises a plurality of augmenting layer blocks that each receive as input a respective input augmenting hidden state for each token in the current input sequence and process the respective input augmenting hidden states for each of the tokens in the current input sequence to generate a respective output augmenting hidden state for each of the tokens in the current input sequence;
processing the current input sequence using a base neural network, wherein the base neural network comprises a plurality of base layer blocks that each receive as input a respective input base hidden state for each token in the current input sequence and process the respective input base hidden states for each of the tokens in the current input sequence to generate a respective output base hidden state for each of the tokens in the current input sequence, the processing comprising, for a particular base layer block:
obtaining the respective output base hidden states for each of the tokens in the current input sequence generated by the particular base layer block;
obtaining the respective output augmenting hidden states for each of the tokens in the current input sequence generated by a particular augmenting layer block of the augmenting neural network that corresponds to the particular base layer block;
generating a respective transformed augmenting hidden state for each of the tokens in the current input sequence by applying a learned transformation to the respective output augmenting hidden states for each of the tokens in the current input sequence;
generating a respective updated output base hidden state for each of the tokens in the current input sequence, comprising: performing cross-attention between (i) the respective output base hidden states for each of the tokens in the current input sequence generated by the particular base layer block and (ii) the respective transformed augmenting hidden state for each of the tokens in the current input sequence; and
providing the respective updated output base hidden states for the tokens in the current input sequence as the respective input base hidden states for a base layer block that follows the particular base layer block in the base neural network; and
processing at least the respective output base hidden state for the last token in the current input sequence to select the output token at the output position.
